(19) United States
(12) Patent Application Publication
(10) Pub. No.: US 2018/0253732 A1
(43) Pub. Date: Sep. 6, 2018

(54) Modeling Social and Emotional Brand-Consumer Relationships

(71) Applicants: Tomer Bakalash, Shdema (IL); Reuven Bakalash, Shdema (IL)

(72) Inventors: Tomer Bakalash, Shdema (IL); Reuven Bakalash, Shdema (IL)

(21) Appl. No.: 15/451,171

(22) Filed: Mar. 6, 2017

(51) Int. Cl. G06Q 30/00; G06Q 30/02; G06Q 50/00; H04L 29/08

(52) U.S. Cl. CPC G06Q 30/01; G06Q 30/0203; G06Q 30/0251; G06Q 30/0201; H04L 67/22; G06Q 50/01

(57) ABSTRACT

The embodiments of the present invention present a conceptual and methodological model that assists in characterizing, measuring, and managing social and emotional relationships between consumers and brands. The model is intended to serve as a working tool for firms to use in managing their consumer-brand relationships. This conceptual and methodological data model, assists in characterizing, measuring, and monitoring social and emotional relationships between consumers and brands.

### CROSS-REFERENCE TO RELATED CASES

The present application claims priority based on U.S. Provisional Application No. 61/327,711 filed Apr. 25, 2010 entitled “Use of Superior Temporal Sulcus Activation as a Predictor for Emotional Engagement and Subsequent Memorability”, and on International (PCT) Patent Application No. PCT/IL2011/000326 filed Apr. 17, 2011 entitled “Method and System for Determining Memorability of Audio and/or Visual Content”, and of U.S. application Ser. No. 13/636,969 filed Sep. 24, 2012 entitled “Method and System for Determining Potential Memorability of Audio and/or Visual Content”, and is a Continuation in Part of U.S. application Ser. No. 14/603,491 filed Jan. 23, 2015 entitled “Brand-Self Perceptual Neural Model Utilizing the Superior Temporal Sulcus,” all four of which are hereby incorporated by reference.

### FIELD OF THE INVENTION

The present invention relates to E-commerce, communication, WEB-based social-media, business management, brain imaging, and marketing, and more particularly to modeling social and emotional relationships between brands and consumers.

### BACKGROUND

Branding is a set of marketing and communication methods that helps to distinguish a company from its competitors and creates a lasting impression in the minds of customers. The key components that form a brand's toolbox include the brand's identity, brand communication (such as logos and trademarks), brand awareness, brand loyalty, and various branding strategies (brand management). Reaching a valuable brand prestige requires a commitment to a particular way of doing business. A corporation that exhibits a strong brand culture is dedicated to producing intangible outputs, such as customer satisfaction, reduced price sensitivity and customer loyalty. A brand is in essence a promise to its customers that they can expect long-term security, a competitive frame of reference, and consistent delivery of functional as well as emotional benefits. When a customer is familiar with a brand and favors it over its competitors, then this is when a corporation has reached a high level of brand equity. In the 21st century, where there is often little to differentiate between products, branding remains the last bastion for differentiation.

A consumer-brand relationship is the relationship that consumers think, feel, and have with a product or company brand. For more than half a century, studies have been performed to help managers and stakeholders understand how to drive favorable brand attitudes, brand loyalty, repeat purchase, customer lifetime value, customer advocacy, and communities of like-minded individuals organized around brands. Research progressed in this area, with inspiration from attitude theory and, later, socio-cultural theories, but a perspective introduced in the early 1990s offered new opportunities and insights. The new paradigm focused on considering the relationships that are formed between brands and consumers an idea that had gained traction in business-to-business marketing scholarship, which studies the physical relationships formed between buyers and sellers.

### SUMMARY

The embodiments of the present invention present a conceptual and methodological model that assists in characterizing, measuring, and managing social and emotional relationships between consumers and brands. The model is intended to serve as a working tool for firms to use in managing their consumer-brand relationships.

This conceptual and methodological data model, termed Brandship, assists in characterizing, measuring, and monitoring social and emotional relationships between consumers and brands. It stems from research in the fields of marketing communication and social media analytics, as well as research into the association between the neural activation patterns in the human brain and the effectiveness of marketing communications. The model is based on the conclusion that consumers transfer their norms and values from the interpersonal and social domain to the consumption-economic sphere.

The Brandship model provides three layers of indications for managing consumer-brand relations.
First, it offers a typology of different kinds of relational types (such as friendship, marriage, casual relationship, professional, and nostalgic).
Second, it assists in determining the quality of the consumer-brand relationship, using qualitative and quantitative variables (such as commitment, dependency, love, and trust).
Third, the model monitors consumer-brand relationship dynamics (how the relationship evolves, builds, grows, and declines).

In order to assess these three different layers of the data model (i.e. typology, consumer-brand relationship quality, and relationship-dynamics), Brandship utilizes various indicators:

1) Monitoring and analyzing social-media conversations;

2) Neural activity levels and patterns in the superior temporal sulcus (STS) (as well as various connected brain regions); and

2) Questionnaires, interviews, and focus groups.

### BRIEF DESCRIPTION OF THE DRAWINGS

FIG. 1. Components of the data model

FIG. 2. Data model generator, its inputs and output

FIG. 3. Parameters inputs of the data model generator

FIG. 4. Main factors of the neural activity patterns

FIG. 5. Method of measuring and processing the neural activity of the STS and the related neural connectivity networks, in the human brain

FIG. 6. Method for determining neural activity levels and patterns of brand's marketing communication

FIG. 7. Significant effect in the left and right STS for memorable ads in comparison to unmemorable ads.

FIG. 8. An exemplary system for neural measuring of communication-elicited emotional arousal

FIG. 9. Block diagram illustrating the internal architecture of a computing system for generating and implementing the data model of present invention

FIG. 10. Stages of characterizing, changing, and managing the social and emotional relationships between consumers and brands.

### DETAILED DESCRIPTION OF THE EMBODIMENTS OF THE INVENTION

The invention generally relates to a system and method for modeling and optimizing the management of consumer-brand relationships for firms and individuals. A consumer-brand relationship is the relationship that consumers think, feel, and have with a product or company brand.

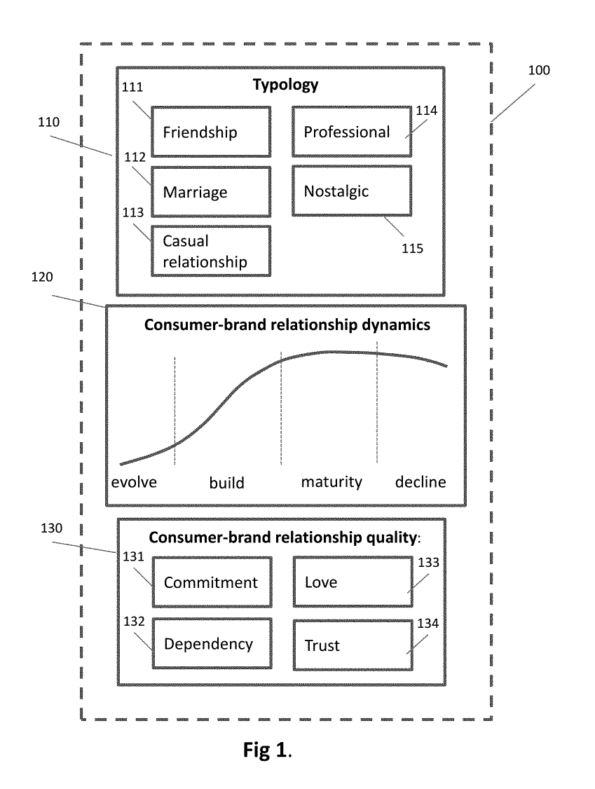

The embodiments of the present invention teach a conceptual and methodological model, to assist in characterizing, measuring, and managing social and emotional relationships between consumers and brands. The model provides three layers of indications for managing consumer-brand relations. The data model, termed Brandship, is presented in FIG. 1. It consists of three layers.

The first layer 110, offers a typology of different kinds of relational types; in one aspect of the present invention these are five types: friendship, marriage, casual, professional, and nostalgic.

Friendship 111, is a relationship of mutual affection between people, including characteristics of affection, sympathy, empathy, honesty, altruism, mutual understanding, compassion, enjoyment of each other's company, and trust, and the ability to be oneself and express one's feelings.

Marriage, 112, is principally an institution in which interpersonal relationships are acknowledged. Individuals may marry for several reasons, including legal, social, libidinal, emotional, financial, spiritual, and religious purposes. Whom they marry may be influenced by socially determined rules, prescriptive marriage rules, and individual desire.

Casual relationship, 113, is a physical and emotional relationship between two people who may have casual sex or a near-sexual relationship without necessarily demanding or expecting the extra commitments of a more formal romantic relationship. Motives for casual relationships vary.

In professional relationships, 114, commitment, dependency, and trust are critical factors for developing and enhancing effective long-term relations.

Nostalgic relations 115 refer to a general interest in the past, and in personalities and events from the past, especially the “good old days” from earlier in one's life. Smell and touch are strong evokers of nostalgia due to the processing of these stimuli as they first pass through the amygdala,

the emotional seat of the brain. These recollections of one's past usually concern important events, people one cares about, and places where one has spent time. Music and weather can also be strong triggers of nostalgia. Nostalgic preferences, and the belief that the past was better than the present, have been linked to biases in memory.

The second layer of the Brandship model is consumer-brand relationship dynamics, 120. In one aspect of the present invention, there is a relationship cycle of four or more stages, e.g. a four-stage cycle:

The first is the evolving stage, 121, where the consumer is introduced to the brand. In order to nourish consumer awareness during this stage, brands make a promotion to new consumers. During this stage the consumer may seek to familiarize him/herself with the brand's products in the market, and when more products of the brand are sought the consumer enters the next stage.

The next is the build stage, 122. In this stage the consumer relations with the brand intensify, resulting in increased purchases.

The next is the maturity stage, 123. In the maturity stage of the consumer/brand life cycle, the brand is well known and its products are bought by the consumers. New products of the brand may be anticipated by the loyal consumer. In the maturity phase the brand demand levels off and purchase volume increases at a slower rate.

The fourth stage in the consumer/brand relationship cycle is the decline phase, 124. By this time the consumer is well familiar with the brand's products. After the peak in the maturity stage, a downward slide in consumer attention begins. Eventually, the purchase volume may drop to the point where the consumer no longer has a special interest in the brand.

The third layer of the Brandship model is the consumer-brand relationship quality, 130 the relationship that consumers, think, feel, and have with a product or company brand, e.g. commitment 131, dependency 132, love 133, and trust 134.

Thus, as one of its aspects, the invention provides a triple-layered model for assisting in the processes of characterizing, measuring, and monitoring the social and emotional relationships between consumers and brands, comprising typology, consumer-brand relationship dynamics, and consumer-brand relationship quality.

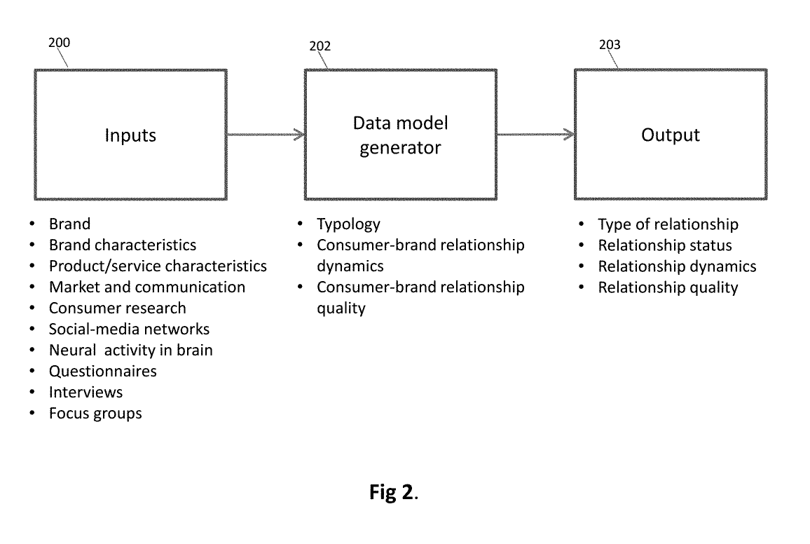

FIG. 2 provides a scheme of the Brandship data model generator, including its inputs and outputs. A model generator 202, may be implemented by one or more computing device. The generator takes the inputs 200, and generates output 203 in accordance with the Brandship model parameters, such as the consumer-brand relationship that consumer(s), think or feel they have with a product or company brand social network, which may be in the form of a written report, diagram, table, list, or other.

The Brandship conceptual and methodological data model assists in characterizing, measuring, and monitoring social and emotional relationships between consumers and brands. As described above, the model consists of three layers: typology, consumer-brand relationship dynamics, and consumer-brand relationship quality.

In accordance with one or more embodiments, the input 200 of the model generator comprises a set of parameters measured, provided, or acquired, that relate to the consumer and brand (to be described later in detail), such as:
Brand
Brand characteristics
Product/service characteristics
Market and communication
Consumer research
Social-media networks
Neural activity in the brain
Questionnaires
Interviews
Focus group results.

In accordance with one or more embodiments, the output 203 of the model parameter generator comprises a set of parameters that summarize the consumer/brand relationships, such as:
Type of relationship
Relationship status
Relationship dynamics
Relationship quality.

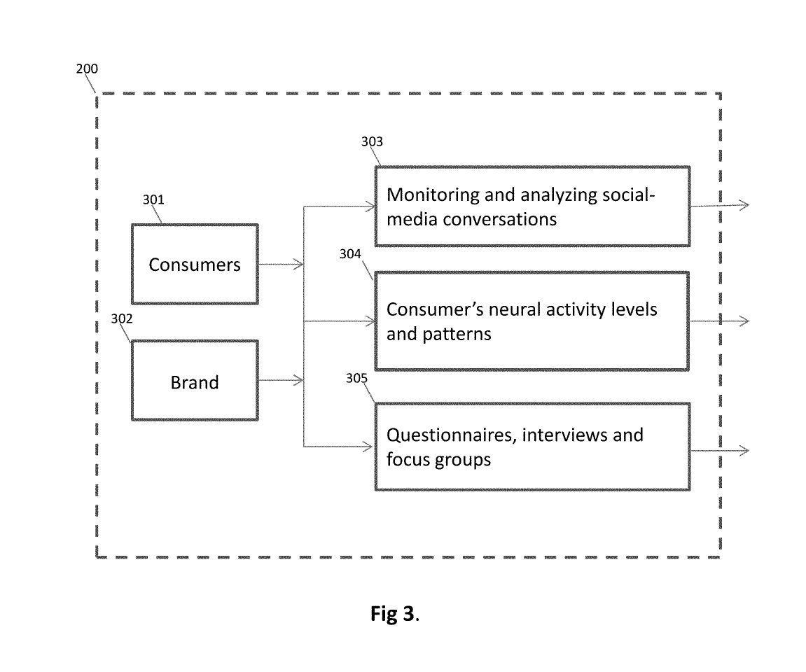

The Brandship data model is fed by input parameters from different sources. These parameters are aggregated and integrated according to the model's structure. FIG. 3 provides an overview of the inputs to a model parameter generator in accordance with one or more embodiments of the present disclosure. The inputs consist of various indicators, related to the customer 301 and to the brand 302, which are necessary for assessing the layers of the Brandship model (i.e. typology, relationship quality and relationship-dynamics), organized in three levels:
1. Monitoring and analyzing social-media conversations;
2. Consumer's neural activity levels and patterns; and
3. Questionnaires, interviews, and focus groups.

Monitoring and Analyzing Social-Media Conversations (FIG. 3, 303).

This level of indicators, as input for the model parameter generator, is gathered by the active monitoring of social media channels. This is one way to provide input for the volume and sentiment of online conversations about a brand. These channels are comprised of blogs, wikis, news sites, micro-blogs such as Twitter, social networking sites, video/photo-sharing websites, forums, message boards, and user-generated content in general. These data are gathered from stakeholder conversations on digital media and processed into structured insights, leading to more information relating to consumer-brand relations. Monitoring and analyzing social media is well known in prior art, and done extensively today. A variety of took to facilitate the monitoring of social media channels have been created by several different providers (e.g. Socialbakers, Hootsuite, Pagerduty, and many more).

Consumer's Neural Activity Levels and Patterns (FIG. 3, 304).

The evaluation of neural activity levels and patterns is based on neural measuring of communication-elicited emotional arousal, and of social cognitive processes in the relationship with the brand's marketing communication. The neural measuring is grounded in an underlying research that discovered a link between ad memorability and excessive neural activation of the STS, as described in great detail in application Ser. No. 14/603,491 “Brand-Self Perceptual Neural Model Utilizing The Superior Temporal Sulcus,” to which the present application claims priority. Memorability is an important proxy of a brand's marketing communication effectiveness. The STS is a brain structure indicative of social perceptual and social cognitive processes. In accordance with one aspect of the invention, one or more individuals are exposed to the audio and/or visual marketing content, and the extent of stimulation of one or both of the STS's, as well as various connectivity brain regions, such as Amigdale and Precuneus, is scored. Its activation is measured by neural means. The neural activation levels and the neural patterns of the STS and of related neural connectivity networks, are measured, and then calculated along with differential variables such as gender, motivation, emotions, cognitive load capacity, and other psychographic variables, for neural activity levels and patterns (NALP), as one of the inputs of the Brandship model generator.

Social cognition is a level of analysis that aims to understand social-psychological phenomena by investigating the cognitive processes that underlie them. Social cognitive processes involve perception, judgment, and memory of social stimuli; the effects of social and affective factors on information processing; and, the behavioral and interpersonal consequences of cognitive processes. All these are processes by which impressions make inferences about the self and other people. These processes make use of attribution-contextual information cues, and are affected by differential variables such as an individual's gender, motivations, emotions, cognitive load capacity, and other psychographic variables. In our Brandship model some or all of these differential variables are measured and given differential weights, in order to determine the social cognitive processing affect on NALP.

Social cognitive processes are accompanied by the emotional reactions of the communication's target audience. These reactions are commonly measured by means of emotional valence (the emotional value associated with a stimulus) and emotional arousal. Therefore, our model specifically measures both valence and arousal of the viewer's reactions to the communicated stimuli, and attributes weights to these values in the calculation of NALP.

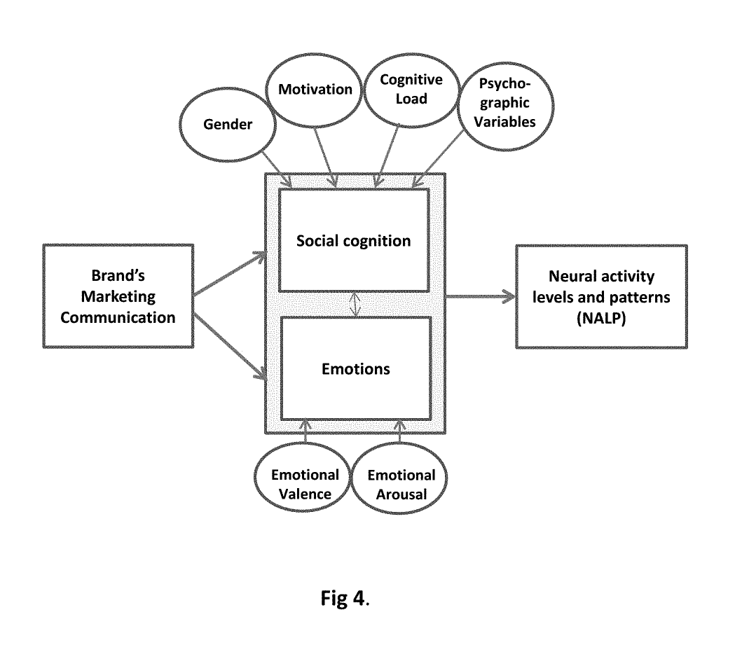

The main factors of the neural activity patterns, as depicted in FIG. 4, are social cognition and emotions. These are affected by the individual's differential variables: motivation, cognitive load, and psychographic variables, and emotional valence and emotional arousal; these may vary according to the individual's gender.

Some or all of the differential variables are weighted with the measured STS score. Emotional valence is one of the differential variables having a binary value, which can invert the meaning of the individual STS score, e.g. from a positive to a negative attitude towards the specific marketing material. Emotional arousal, another differential variable, having high and low values, may indicate the temporal emotional state of the individual induced by the marketing communication stimuli. These two parameters must be taken into account when processing the STS score (and related neural connectivity networks) for the final NALP. Another differential parameter is the individual's gender, which may be relevant in some marketing communications but irrelevant in others. The individual's parameters of emotional valence, emotional arousal, and gender, which are externally accessible, as well as other differential variables according to needs, must be weighted with the STS score to normalize the NALP results across multiple individuals.

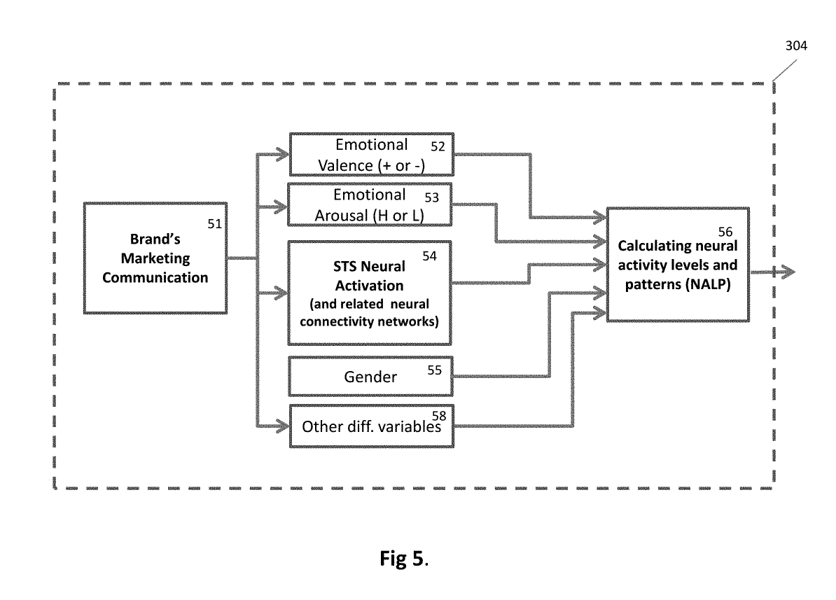

FIG. 5 depicts the method of measuring and processing the neural activity of the STS and the related neural connectivity networks, in the human brain. The related neural connectivity networks are comprised of the Precuneus and Amigdale. The measured neural activation 54 is indicative of the social cognition and emotions of an exposed individual to a brand's marketing material 51. Some or all of the differential variables must be weighted with the measured STS score. Emotional valence 52 is one of the differential variables having a binary value, which can invert the meaning of the individual STS score, e.g. from a positive to a negative attitude towards the specific marketing material. Emotional arousal 53, having high and low values, may indicate a temporal emotional state of the individual, induced by the marketing communication stimuli. These two parameters must be taken into account when processing the STS score and related neural connectivity networks, for the NALP 57. Another differential parameter is the individual's gender 55, which may be relevant in some marketing communications but irrelevant in others. The individual's parameters of emotional valence, emotional arousal and gender, which are externally accessible, as well as other differential variables 58 according to needs, must be weighted with the STS score to normalize the final NALP result across multiple individuals. The individual's parameters of emotional valence, emotional arousal, and gender, which are externally accessible, as well as other differential variables according to individual needs, must be weighted with the STS score in order to normalize the final NALP result across multiple individuals. The neural activity is given by the following NALP expression:

NALP=STS_{activation}_{_}ₗₑᵥₑₗ*k_{gender}*k_{valence}*kₐᵣₒᵤₛₐₗ*kₒₜₕₑᵣ

The constants k of the different factors must be specifically adapted to each examined individual in order to gain a normalized NALP result. The neural stimulation level of the brain STS_{activation}_{_}ₗₑᵥₑₗ is a nature-based product, but the set of constants k cultivates its meaning. For example, the same scored activation of STS for two different individuals, a man and woman (k_{gender}), may get a different interpretation, in some cases even inverted. Consequently, the NALP expression is not unequivocal with STS scores—rather, it is a product of STS scores and differential variables.

As an example of an unequivocal meaning of the STS scores, we can use a marketing communication of cheap flights to London. Assuming that such an ad addresses both genders equally, and assuming that a typical female STS score is different from that of a male, then we need to adjust the k_{gender} according to the individual's gender. We then measure emotional-valence and emotional-arousal as perceived by the stimuli's viewers and give these parameters their weights k. Measuring emotional-valence and emotional-arousal can be done using self-report questionnaires filled in by the examined individual, or by using an external representative sample.

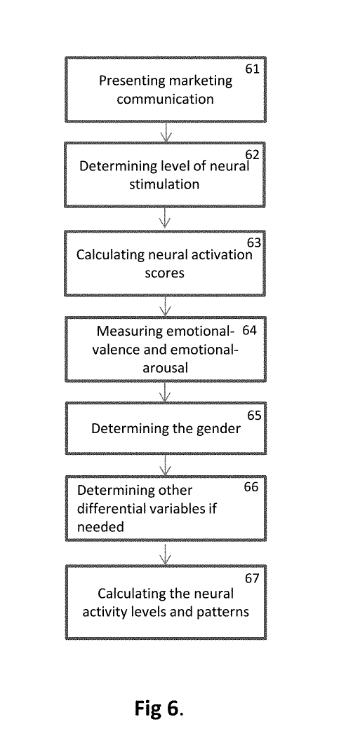

Thus, as shown in the flowchart in FIG. 6, as one of its aspects a method is provided for determining neural activity levels and patterns of a brand's marketing communication, comprised of:
1. Presenting the marketing communication items to one or more individuals 61; and
2. Determining a level of neural stimulation in one or more brain regions in each of the one or more individuals during the exposure of each individual to the brand's marketing communication items, and generating data indicative of the level of stimulation during the presentation of each of the content items 62; and
3. Calculating one or more neural activation score of each of the one or more content items 63; and
4. Measuring emotional-valence and emotional-arousal of the said one or more individuals 64; and
5. Determining the gender of the said one or more individuals 65; and
6. Determining other differential variables if needed 66; and
7. Analyzing the neural activity levels and patterns by applying the NALP equation on the factors of memorability scores, emotional-valence, emotional-arousal, and gender for each of the said individuals 67.

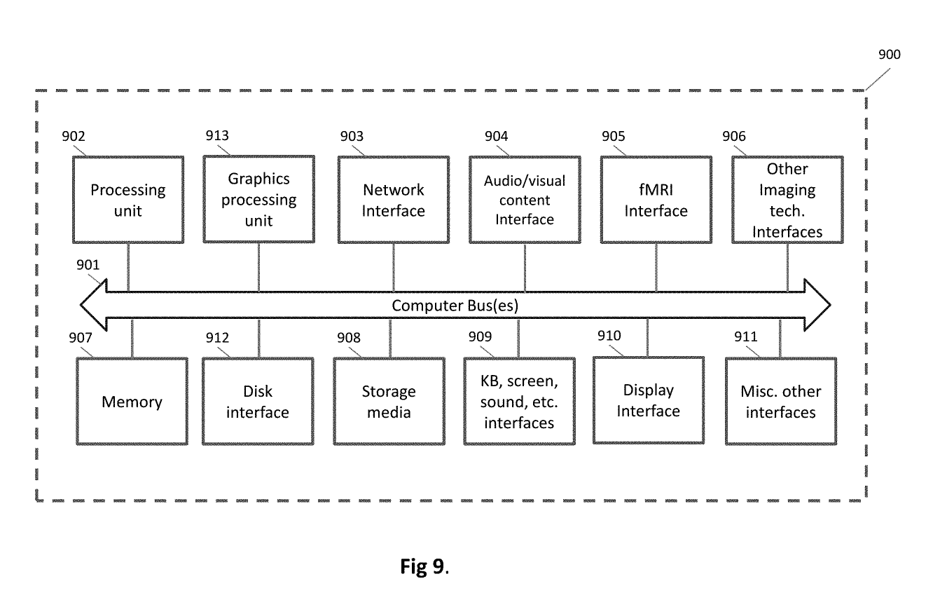

In another of its aspects, the invention provides a system for determining neural activity levels and patterns of a brand's marketing communication. The system of the invention includes one or more devices for presenting audio and/or visual content to an individual, an apparatus for determining the extent of stimulation in one or both of the STS and the various connected brain regions of the individual during exposure of the individual to the audio and/or visual content, and a computing device to determine neural activity levels and patterns. The computer system for the neural measuring of communication-elicited emotional arousal is shown in FIG. 9, and is described as follows. For exposure to visual content, a screen may be used that is positionable in front of the individual. For exposure to audio content, loudspeakers or earphones may be used. Means for determining the extent of stimulation in one or both of the amygdale and the STS may include, for example, an fMRI apparatus, and processing means configured to analyze images obtained by the fMRI apparatus to score the neural stimulation of one or both of the STS's and the various connected brain regions.

In one embodiment, fMRI is used to obtain images of one or both of the STS's and the various connected brain regions, providing indications of the level of neural stimulation in the brain. The fMRI images can then be analyzed and the extent of neural stimulation in the STS and/or the various connected brain regions can be scored. In other embodiments, brain imaging by other techniques, such as positron emission tomography, magnetoencephalography, and single photon emission computer tomography, may be used to monitor neural activity in the STS and various connected brain regions.

Thus, in these aspects, the invention provides a system for determining neural activity levels and patterns of a brand's marketing communication, comprising:
1. One or more presentation devices for presenting the marketing communication items to an individual;
2. A monitoring apparatus for monitoring the level of neural stimulation in one or both of the STS's and various connected brain regions of an individual during his/her exposure to the marketing communication items, and generating data indicative of the level of stimulation of one or both of the amygdala and the STS;
3. A processing unit including a CPU, which is configured to process data generated by the monitoring apparatus from one or more individuals to calculate one or more memorability scores of each of the one or more content items presented to the individual; and
4. A computing device configured to calculate the marketing communication effectiveness based on the memorability scores, emotional valence, emotional arousal, and gender, applying the NALP expression.

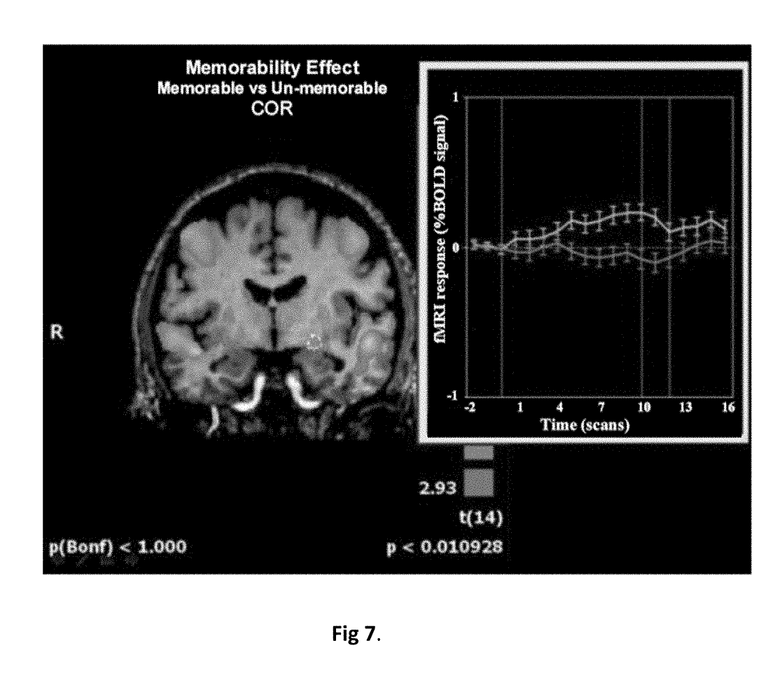

FIG. 7 shows the results of the GLM analysis in the sub-cortical structures described above for the two types of ads. The results revealed a significant effect in the left and right STS for memorable ads in comparison to unmemorable ads. The insert to FIG. 7 shows a graph of the MRI response for memorable ads (upper curve) and unmemorable ads (lower curve), which revealed significant differences in neural activation in the amygdala between memorable and unmemorable ads.

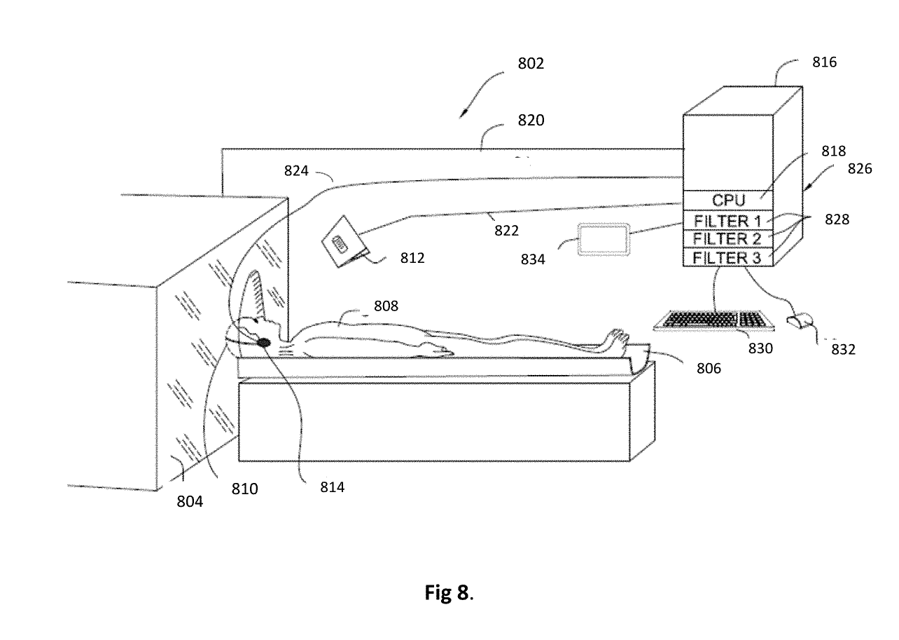

FIG. 8 shows an exemplary system 802 for measuring a consumer's communication-elicited emotional arousal, in accordance with one embodiment of the invention. The system 802 comprises an apparatus for monitoring neural activity in one or both of the amygdala and the STS. In the embodiment of FIG. 8, the apparatus for monitoring the neural activity is an fMRI apparatus 804. A table 806 allows an individual 808 to lie with his/her cranium 810 (shown in phantom) inside the fMRI apparatus 804. The system 802 also comprises a screen 812 that is positioned so as to allow the individual 808 to view the screen while lying on the table 806. A pair of speakers (not shown) or a set of earphones 814 allows exposure of the individual 808 to audio content while lying on the table 806.

The system 802 further comprises a processing unit 816 that includes a CPU 818. The CPU communicates with the monitoring apparatus 804 over a communication line 820. The CPU 818 further communicates with the screen 812 over a communication line 822, and with the earphones 814 over a communication line 824. The processing unit 816 also includes a memory 826 comprising one or more files 828 where data indicative of audio and visual content may be stored prior to presenting the content to the individual 808. A user input device such as a keyboard 830 or a computer mouse 832 is used to input data into the memory, with such data identifying the subject 808 or data relating to the content to which the individual 808 is to be exposed. Processing of data provided by the monitoring apparatus is carried out by the CPU 818 and may be stored in one of the files 828 and displayed on a display device, such as a monitor 834.

The CPU 818 is configured to access content data stored in the memory 826 and to present to the individual 808 with a predetermined sequence of content. The sequence of content may include, for example, one or more ads. Audio content is presented to the individual 808 by the CPU 818 over the communication line 824 to the earphones 814. Visual content is presented to the individual 808 by the CPU 818 on the screen 812 over the communication line 822. Visual and audio content may be presented simultaneously or in alternation. During presentation of the content to the individual 808, neural activity in one or both of the amygdale and the STS is monitored by the neural activity monitoring apparatus 804. Data collected by the apparatus 804 are transmitted to the processing unit 816 over the communication line 820, and are initially stored in one of the data files 828.

The CPU is configured to access the data received from the apparatus 804 and to determine the level of neural activity in one or both of the STS and various connected brain regions.

Questionnaires, interviews, and focus groups are the third layered inputs provided to the Brandship model generator by direct interaction with consumers (FIG. 3, 305).

A questionnaire is a research instrument consisting of a series of questions and other prompts for the purpose of gathering information from consumers. They are often designed to aid in the statistical analysis of the responses, but this is not always the case. Questionnaires have advantages over some other types of surveys in that they are inexpensive, do not require as much effort from the questioner as do verbal or telephone surveys, and often have standardized answers that make it simple to compile the data.

An interview is a conversation where questions are asked and answers are given. It is a one-on-one conversation where the interviewer asks questions of the interviewee, who is a potential or existing consumer of a brand. Such interviews usually involve a transfer of information from the interviewee to the interviewer. They may take place face-to-face and in person, although modern communications technologies such as the Internet have enabled conversations to take place in which the parties are separated geographically, such as with videoconferencing software, and of course telephone interviews can happen without visual contact. Effective interviews are highly structured conversations in which specific questions are asked in a specified order, with the object being to explore a consumer's subconscious motives. Typically, the interviewer has some way of recording the information that is gleaned from the interviewee, often by writing it down using a pencil and paper, and sometimes transcribing with a video or audio recorder, depending on the context and extent of information and the length of the interview.

A focus group is a form of qualitative research in which a group of existing or prospect consumers are asked about their perceptions, opinions, beliefs, and attitudes towards a product, service, concept, advertisement, idea, or packaging. Questions are asked in an interactive group setting where participants are free to talk with other group members. During this process, the researcher either takes notes or records the vital points he/she is obtaining from the group. Care should be taken in selecting members of the group, in order to obtain effective and authoritative responses.

FIG. 9 is a detailed block diagram illustrating the internal architecture of a computing device, representing various forms of digital computers, such as laptops, desktops, workstations, personal digital assistants, servers, blade servers, mainframes, and other appropriate computers, in accordance with one or more embodiments of the present disclosure. As shown, internal architecture 900 includes one or more general purpose processing units, processors, or processing cores, (also referred to herein as CPUs) 902, which interface with at least one computer bus 901. In addition, one or more graphics processing units, either separated from the processing unit (discrete) and interfacing with computer bus, or sharing the same silicon chip with the processing unit (integrated), can be included. Also interfacing with computer bus are computer-readable medium, or media, 908; a network interface 903 connectable to the Internet and other networks; memory 907, e.g. random access memory (RAM), run-time transient memory, read only memory (ROM), etc.; a media disk drive interface 908 as an interface for a drive that can read and/or write to media, including removable media such as floppy, CD-ROM, DVD, etc. media; a display interface 910 as an interface for a monitor or other display device; and keyboard, screen, mouse, sound and the like interfaces 909; and, miscellaneous other interfaces 911 not shown individually, such as parallel and serial port interfaces, a universal serial bus (USB) interface, and the like. In addition, connected with the computer bus are audio/visual content interfaces 904, for interfacing with the brand's marketing communication; an fMRI scanner interface 905; and other imaging technologies interfaces 906, such as positron emission tomography, magnetoencephalography, and single photon emission computer tomography.

The memory 907 interfaces with computer bus 901 so as to provide information stored in memory CPU 902 during the execution of software programs, such as an operating system, application programs, device drivers, and software modules that comprise a program code; and/or computer-executable process steps incorporating functionality, e.g. one or more of the process flows as described herein. CPU 902 first loads computer-executable process steps from storage, e.g. memory, computer-readable storage medium/media, a removable media drive, and/or other storage devices. CPU can then execute the stored process steps in order to execute the loaded computer-executable process steps, while interfacing with the connected peripheral devices such as a disk, storage media, keyboard, mouse, screen, display, audio/visual devices, and fMRI and other imaging devices, as well as with the WEB through the Internet and other local and global networks.

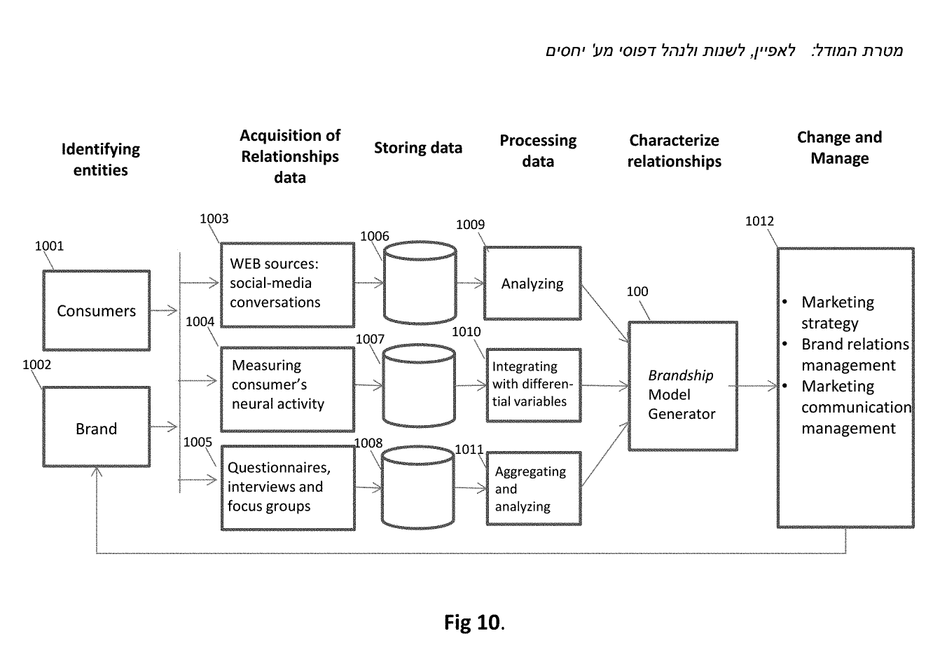

Thus, as one of the aspects of the present invention, a method is provided for characterizing, changing, and managing the social and emotional relationships between consumers and brands, as described in FIG. 10, comprising:
1. Identifying participating entities: consumer 1001 and brand 1002. The consumer can stand for an individual consumer, multiple consumers, like-minded individuals organized around brands, or communities of consumers. The brand can stand for a product, a brand, or a company.
2. Acquisition of relationship data between the participating entities, from three different sources, comprised of:
   Monitored social-media conversations 1003; and
   Consumers' neural activity levels and patterns 1004; and
   Questionnaires, interviews and focus groups 1005.
3. Storing the acquired data in computer storage devices 1006-1008.
4. Processing the stored data, including:
   Analyzing the monitored social-media conversations 1009; and
   Integrating the said consumer's neural activity levels and patterns with the consumer's differential variables 1010; and
   Aggregating and analyzing the said data from questionnaires, interviews, and focus groups 1011; and
5. Characterizing the brand-consumer relations according to the Brandship data model; and
6. Presenting a report to be applied to changing marketing strategy according to the characterized brand-consumer relationships, and managing the brand relations and marketing communication accordingly.

Thus, as one of the aspects of the present invention, a system for characterizing, changing, and managing the social and emotional relationships between consumers and brands is provided, comprised of:
1. A computer system, comprising one or more general-purpose and graphics processing units;
   disks and other storage media; a keyboard, screen, mouse, and other peripheral equipment;
   and said computer system connectable to WEB resources; audio/visual equipment; and
   medical imaging systems (such as fMRI).
2. Said general purpose processing unit storing instructions that are operable, when executed, to cause the computer system to perform operations, comprised of:
   a. Identifying two entities having inter entity relationships, comprising:
      Consumer entity, which may stand for the individual consumer, multiple consumers, like-minded individuals organized around brands, or communities of consumers;
      Brand entity, which can stand for a product, a brand, or a company.
   b. Acquiring data related to brand-consumer relations, from three different sources, including:
      Monitored data from WEB and other electronic sources 1003;
      Consumers' neural activity levels and patterns measured in STS and connected brain regions, by imaging devices 1004;
      Direct interaction with consumers 1005 (such as questionnaires, interviews, and focus groups)
   c. Storing acquired data in computer storage media 1006-1008
   d. Processing the stored data, including:
      Analyzing the WEB and other electronic source data 1009;
      Integrating the neural activity data with consumers' differential variables 1010;
      Aggregating and analyzing the direct interaction data 1011.
   e. Characterizing the brand-consumer relations according to the Brandship data model by the model generator 100.
   f. Presenting a report to be applied to changing marketing strategy according to the characterized brand-consumer relationships, and managing the brand relations and marketing communication accordingly 1012.

Those skilled in the art will recognize that the methods and systems of this invention may be implemented in many manners, and as such are not limited by the embodiments and examples. In other words, functional elements being performed by single or multiple components, in various combinations of hardware and software or firmware, as well as individual functions, may be distributed among software applications at either the client or server or both. In this regard, any number of the features of the different embodiments described herein may be combined into single or multiple embodiments. Alternate embodiments having fewer or more than all of the features described herein are also possible. Functionality may also be, in whole or in part, distributed among multiple components, in manners now known or to become known in the future. Thus, a myriad of software/hardware/firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein, as would be understood by those skilled in the art now and hereafter.

While the system and method have been described in terms of one or more embodiments, it should be understood that the disclosure need not be limited to the disclosed embodiments. It is intended to cover various modifications and similar arrangements included within the spirit and scope of the claims, which should be accorded the broadest interpretation so as to encompass all such modifications and similar structures. The present disclosure includes any and all embodiments of the following claims.

What is claimed is:

1. A method for analyzing relationships between consumers and brands, comprising:
Brandship model of social and emotional consumer-brand relationship typology, dynamics and quality, implemented by the steps of:
a. Identifying participating entities: one or more consumers and brand.
b. Acquiring relationship data between the participating entities, from different sources, comprised of:
a. Monitored social-media conversations through the Internet and local networks; and
b. Each consumers' neural activity levels and patterns, obtained by medical imaging systems from superior Temporal Sulcus (STS) and connected brain regions; and
c. Inputs provided by questionnaires, interviews, and focus groups by direct interaction with one or more consumers; and
d. Each consumer's differential variables of gender, motivation, emotions, and cognitive load capacity, measured and given differential weights;
c. Storing the acquired data, from each source separately, in computer storage devices.
d. Processing the stored data by a brandship model generator, including:
Analyzing the monitored social-media conversations; and
Integrating each consumer's neural activity levels and patterns with said consumer's differential variable for neural activity levels and patterns; and
Aggregating and analyzing the data of direct interaction with one or more consumers; and
e. Characterizing the brand-consumer relations for typology, relationship dynamics and relationship quality, according to said brandship model; and
f. Presenting a report.

2. The method of claim 1, wherein the consumer is an individual consumer, multiple consumers, like-minded individuals organized around brands, or communities of consumers.

3. The method of claim 1, wherein the brand Is a product, a brand, or a company.

4. (canceled)

5. The method of claim 1, wherein the direct interaction with consumers is done by questionnaires, Interviews, and focus groups

6. The method of claim 1, wherein the consumers' neural activity levels and patterns is based on neural measuring of Superior Temporal Sulcus.

7. The method of claim 1, wherein the consumers' neural activity levels and patterns is based on neural measuring of Superior Temporal Sulcus and connectivity brain regions.

8. The method of claim 1, wherein the consumers' neural activity levels and patterns is based on neural measuring of each consumer's brain.

9. A system for measuring and characterizing social and emotional relationships between consumers and brands, comprised of:
a. A brandship model of social and emotional consumer-brand relationship typology, dynamics and quality;
b. A computer system, for implementing said brandship model, comprising one or more general-purpose and graphics processing units; storage media; a keyboard, screen, end mouse; and said computer system connectable to Internet resources; audio/visual equipment; and medical imaging systems;
c. Said general purpose processing unit storing instructions that are operable, when executed, to cause the computer system to perform operations, comprised of:
identifying entities having Inter entity relationships, comprising:
One or more consumer entity; and
Brand entity.
Acquiring data related to brand-consumer relations, from three different sources, including:
Monitored data from Internet or any electronic sources; and
One or more consumers' neural activity levels and patterns, obtained by medical imaging systems from Superior Temporal Sulcus (STS) and connected brain regions; and
Each consumer's differential variables of gender, motivation, emotions, and cognitive load capacity, measured and given differential weights;
Inputs provided by questionnaires, interviews, and focus groups by direct interaction with one or more consumers;
Storing acquired data in computer storage media;
Processing the stored data, including:
Analyzing the Internet and local networks data; and
Integrating the neural activity data with each consumers' differential variables; and
Aggregating and analyzing the direct interaction data;
Characterizing the brand-consumer relations according to the brandship data model;
Presenting a report.

10. The system of claim 9, wherein the consumer is an Individual consumer, multiple consumers, like-minded individuals organized around brands, or communities of consumers.

11. The system of claim 9, wherein the brand can stand for a product, a brand, or a company.

12. The system of claim 9, wherein acquiring data of each consumers' neural activity levels and patterns can be done by fMRI scanner or by positron emission tomography, magnetoencephalography, and single photon emission computer tomography.

13. The system of claim 9, wherein neural activity levels and patterns are measured by imagine devices in STS and connected brain regions.

14. The system of claim 9, wherein the direct interaction with one or more consumers is done by questionnaires, interviews, and focus groups.

15. (canceled)

16. The system of claim 9, wherein each consumers' neural activity levels and patterns is based on neural measuring of Superior Temporal Sulcus.

17. The system of claim 9, wherein each consumers' neural activity levels and patterns Is based on neural measuring of consumer's brain.

18. The system of claim 9, wherein each consumers' neural activity levels and patterns is based on neural measuring of Superior Temporal Sulcus.
